(19) United States
(12) Patent Application Publication
(10) Pub. No.: US 2007/0291635 A1
(43) Pub. Date: Dec. 20, 2007

(54) METHOD AND APPARATUS FOR SWITCHING BETWEEN OFDM COMMUNICATION MODES

(75) Inventors: Weidong Yang, Schaumburg, IL (US); Jun Tan, Lake Zurich, IL (US); Brian K. Classon, Palatine, IL (US); Kevin L. Baum, Rolling Meadows, IL (US); Vijay Nangia, Algonquin, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/751,658

(22) Filed: May 22, 2007

Related U.S. Application Data
(60) Provisional application No. 60/804,858, filed on Jun. 15, 2006.

(51) Int. Cl. H04J 11/00

(52) U.S. Cl. 370/208

(57) ABSTRACT

An apparatus and method for switching between a first and a second Orthogonal Frequency Division Multiplexing (OFDM) communication mode includes a first step of determining an operational modulation scheme. A next step includes estimating a first performance factor for the modulation scheme in the first communication mode and a second performance factor for the modulation scheme in the second communication mode. A next step includes comparing the first and second performance factors against at least one selection criterion. A next step includes selecting the communication mode in response to the selection criterion and the modulation scheme. A next step includes transmitting on the selected communication mode using the modulation scheme.

### FIELD OF THE INVENTION

The present invention relates generally to a communication system and in particular, to a method and apparatus for switching between multi-carrier communication modes.

### BACKGROUND OF THE INVENTION

Orthogonal Frequency Division Multiplexing (OFDM) is a well-known multicarrier modulation method that is used in several wireless system standards. Some of the systems using OFDM include 5 GHz high data rate wireless LANs (IEEE802.11a, HiperLan2, MMAC), digital audio and digital video broadcast in Europe (DAB and DVB-T, respectively), broadband fixed wireless systems such as IEEE802.16a, and broadband mobile wireless systems IEEE 802.16e and IEEE 802.20. An OFDM system or more specifically an Orthogonal Frequency Division Multiple Access (OFDMA) system can divide the available bandwidth into very many narrow frequency bands (subcarriers), with data being transmitted in parallel on the subcarriers. Each subcarrier utilizes a different portion of the occupied frequency band. In the following, “OFDM” and “OFDMA” are used interchangeably.

Spreading can also be applied to the data in an OFDM system to provide various forms of multicarrier spread spectrum. Such spread-OFDM systems are generally referred to as either Spread OFDM (S-OFDM), multi-carrier CDMA (MC-CDMA), or Orthogonal Frequency Code Division Multiplexing (OFCDM), and are generally referred to herein as S-OFDM. In one specific Spread OFDM, DFT spread OFDMA, different users are assigned orthogonal tones, a frequency spreading is performed on the data symbols over the tones assigned to each user. And Fourier transform matrix is used to perform the redundancy-free frequency spreading. Alternatively, a truncated Fourier transform matrix is used to perform frequency spreading. For systems employing MC-CDMA, spreading can be applied in the frequency dimension and multiple signals (users) can occupy the same set of subcarriers by using different spreading codes. For OFCDM, different users are assigned different mutually orthogonal spreading codes. Spreading can be applied in the frequency dimension, or the time dimension, or a combination of time and frequency spreading can be used. In any case, orthogonal codes such as Walsh codes or Fourier transforms are used for the spreading function, and multiple data symbols can be code multiplexed onto different Walsh codes or Fourier transform sequences (i.e., multi-code transmission).

In general, the following observations can be made:

Firstly, in terms of channel capacity, if the receiver is restricted to MMSE (Minimum Mean Square Error) type equalizers, S-OFDM has a lower capacity than OFDM for many channel types. Even though the cutoff rate of S-OFDM could be higher than OFDM for some channel types. Consequently, when some capacity approaching channel coding scheme is used in conjunction with a simple receiver, S-OFDM has a lower capacity or throughput than OFDM for many channel types.

Secondly, the peak-to-average power ratio (PAPR) of an OFDM transmission is normally higher than that of a similar DFT S-OFDM transmission, i.e. given the same channel coding scheme (e.g. half rate turbo code), modulation scheme (e.g. QAM16), the same number of tones and the same transmission interval, the PAPR of the OFDM transmission is higher. The consequences of a higher PAPR can include a higher current drain on the power amplifier, more heat dissipation, larger form factor, more difficulties to meet requirements specified by regulator bodies such as FCC, higher cost for the handset and so on. A higher PAPR can also lead to the case where a terminal at cell edge cannot sustain a minimum rate reverse link as the maximum transmit power is limited by spectral mask, linearity requirements and so on.

Consequently, it can be seen that both S-OFDM and OFDM provide different solutions to balance power drain and PAPR and throughput, within none of the systems providing an optimum solution under all conditions.

Therefore, a need exists for a method and apparatus that can select an optimum OFDM communication mode dependent upon operating conditions and parameters, and a technique for switching between said selected OFDM modes.

### BRIEF DESCRIPTION OF THE DRAWINGS

The features of the present invention, which are believed to be novel, are set forth with particularity in the appended claims. The invention, together with further objects and advantages thereof, may best be understood by making reference to the following description, taken in conjunction with the accompanying drawings, in the several figures of which like reference numerals identify identical elements, wherein:

FIG. 1 illustrates an OFDM-based communication mode, in accordance with the present invention;

FIG. 2 is a flow chart showing operation of the system of FIG. 1;

FIG. 3 shows a first graphical representation of a comparison of simulation performance of various OFDM systems; and

FIG. 4 shows a second graphical representation of a comparison of simulation performance of various OFDM systems.

Skilled artisans will appreciate that common but well-understood elements that are useful or necessary in a commercially feasible embodiment are typically not depicted or described in order to facilitate a less obstructed view of these various embodiments of the present invention.

### DETAILED DESCRIPTION OF THE EMBODIMENTS

In order to address the above-mentioned need, a method and apparatus is described herein for a method and apparatus that can select an optimum OFDM communication mode dependent upon operating conditions and parameters, and a technique for switching between said selected OFDM modes. In particular the present invention selects between an OFDM mode and an S-OFDM mode. Although the present invention is described with respect to a DFT S-OFDM, it should be recognized that the present invention is also applicable to any other spread OFDM system.

Each of the OFDM and S-OFDM system provides its own benefit. The OFDM has higher capacity than the S-OFDM system when a low complexity receiver is used. As a result, it is beneficial for a terminal to use OFDM for reverse link communication when pathloss is small and/or just a few data tones are used and/or the terminal has a sizeable power amplifier or power reserve. The S-OFDM has lower peak-to-average power ratio (PAR) and therefore lower power drain than OFDM in general. As a result, it is beneficial for a terminal to use S-OFDM for reverse link communication when pathloss is high and/or many data tones are used for reverse link communications and/or the terminal has a low powered power amplifier or low power reserves. The present invention provides a switching procedure for a terminal or base station to switch between these systems so that the benefits of both OFDM and S-OFDM systems can be utilized at the most opportune times. Therefore, in a communication system where both OFDM and S-OFDM are supported, the terminal determines when and how to switch from one transmission scheme to another transmission based on several factors, as will be described below. Optionally, the switching decision can be met at the direction of a base station.

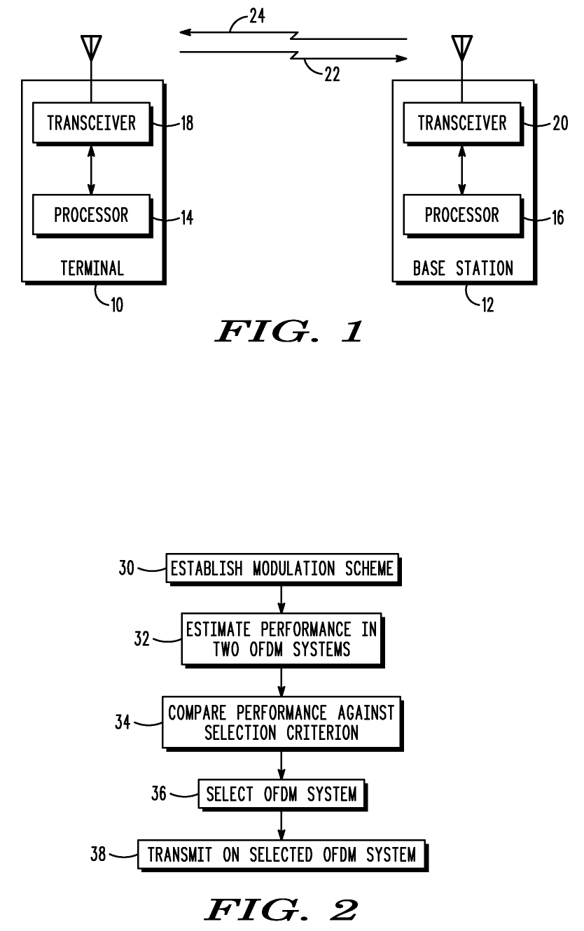

Referring to FIG. 1, an OFDM multi-carrier communication system is shown having a terminal 10 and base station 12. The terminal can be a fixed terminal or a mobile terminal. The base station can also be an access node. The terminal 10 includes a processor 14 and transceiver 18. The base station also includes a processor 16 and transceiver 20. The terminal 10 transmits to a receiving base station 12 on a reverse link 22. The terminal 10 receives from a transmitting base station 12 on a forward link 24. In a multi-carrier system, data from an entity is transmitted on multiple subcarriers. The data can additionally be spread in the frequency or time domains.

In a first embodiment, a terminal 10 is operable to switch between a first and a second Orthogonal Frequency Division Multiplexing (OFDM) communication mode. The terminal includes a transceiver 18 operable to use a modulation scheme and a processor 14. The processor 14 is operable to; estimate a first performance factor for the modulation scheme in the first communication mode and a second performance factor for the modulation scheme in the second communication mode, comparing the first and second performance factors against at least one selection criterion; and select the communication mode in response to the selection criterion and the modulation scheme, wherein the transceiver communicates with a base station to switch to the selected communication mode and transmits on a reverse link of the selected communication mode using the modulation scheme.

In a second embodiment, a base station 12 is operable to switch between a first and a second Orthogonal Frequency Division Multiplexing (OFDM) communication mode. The base station 12 includes a transceiver 20 operable to use a modulation scheme and a processor 16. The processor 16 is operable to; estimate a first performance factor for the modulation scheme in the first communication mode and a second performance factor for the modulation scheme in the second communication mode, comparing the first and second performance factors against at least one selection criterion; and select the communication mode in response to the selection criterion and the modulation scheme, wherein the transceiver communicates with a terminal to switch to the selected communication mode and transmit on a reverse link of the selected communication mode using the modulation scheme.

In practice, transmitted information can be spread across many frequency subcarriers, requiring a pilot tone to be generated for each subcarrier, and/or the information can be spread over fewer frequency subcarriers while spreading the information over a number of time slots (i.e. extending the time duration) to carry the information. Using more frequency subcarriers requires more processing capability but transmits the information quickly, whereas using less frequency subcarriers is simpler but requires more time (slots) to transmit the information, resulting in slower capacity.

Data streams are spread using a standard spreading process, producing a plurality of multiplexed chip streams on the subcarriers. For example, in a scenario where the data and spreading codes are binary, spreading is performed by modulo 2 addition of an orthogonal code (e.g., an 8 chip Walsh code) to data symbol. In 8 chip spreading, data symbols are each replaced by an 8 chip spreading code or its inverse, depending on whether the data symbol was a 0 or 1. More generally, the spreading code is modulated by a complex data symbol selected from a M-ary QAM or M-ary PSK constellation, for example. The spreading code preferably corresponds to a column or a row from a Fourier transform matrix. Alternatively, the spreading code corresponds to a Walsh code from an Hadamard matrix wherein a Walsh code is a single row or column of the matrix. Thus, each data stream outputs a Fourier transform sequence or a Walsh code modulated by the present input data symbol value. Pilot signals are inserted between data transmissions, providing channel estimation to aid in subsequent demodulation and demultiplexing of the transmitted signal. It should be noted that in alternate embodiments of the present invention additional spreading or other operations may occur in spreading. For example, power control and/or data scrambling may be done, as shown in the previous equation.

FIG. 2 is a flow chart showing operation of the system of FIG. 1, in accordance with the preferred embodiment of the present invention. The present invention is best used in association with a reverse link communication. The logic flow begins at step 30 where an operational modulation scheme is established. The modulation scheme may be a relatively simply BPSK, or QPSK modulation scheme, or a more complex M-ary QAM or M-ary PSK, such as QAM16 or 8PSK. Terminals and base stations that have the sophistication to handle the higher order modulation scheme can best use the S-OFDM systems to advantage, as will be detailed below.

At step 32 a first performance factor for the modulation scheme in the first communication mode and a second performance factor for the modulation scheme in the second communication mode is estimated. In operation, the first communication mode is an OFDM or OFDMA system, and the second communication mode is a spread OFDM system such as DFT S-OFDM. The performance factors includes, alone or in combination, power dissipation (i.e. pathloss/pilot strength) in the reverse link, the reverse link modulation scheme, the number of tones used for reverse link transmission, the power de-rating estimate for both transmission modes or either transmission mode, the terminal's battery usage policy, the terminal's remaining battery, whether the terminal is on mains (AC) power or battery (DC) power, the number of tones used and the time duration of transmission, the existence of PAPR reduction zone, a spectral mask requirement, a power class of the terminal, and the base station's receiver capability, as will be detailed below.

At step 34 the first and second performance factors are compared against at least one selection criterion. The selection criterion is different for each performance factor and typically includes a threshold value(s) used in the selection of the preferred communication mode, as will be detailed below.

At step 36 the communication mode is selected in response to the selection criterion and the modulation scheme. Finally, at step 38 transmission occurs on the selected communication mode using the modulation scheme.

In a preferred embodiment, the above steps are performed in the terminal, since it is envisioned that there will be may type of different terminals in the future and a base station will be less capable of keeping track of all these variations versus what each terminal already knows about its capabilities, which can be communicated to the base station. However, in an alternate embodiment, the establishing, estimating, comparing, and selecting steps are performed in a base station, with the results communicated to the terminal for transmitting on the reverse link.

In a communication mode where both OFDM and S-OFDM are supported in the reverse link, it is necessary to trade-off data throughput and battery life. In one example, if a terminal is at cell edge, then it may have to use DFT S-OFDMA to support a minimum rate link, as its transmit power is limited. On the other hand, if a terminal is close to the base station, then it doesn't need a large transmit power to send a high-to-average ratio signal to the base station, and it can afford to use OFDMA. In another example, the existence of a PAPR reduction zone as defined in 802.16e, would make the peak-to-average ratio of OFDMA transmission smaller, and consequently OFDMA can be used at more locations than previously. It can be seen that whether OFDMA or S-OFDMA is the preferred transmission means depends on many factors including the pathloss from the terminal to the base station, the desired throughput, the modulation scheme, and so on.

In one embodiment, the performance factors are power attenuation (e.g. pathloss/pilot strength) in the reverse link, and the selection criterion includes a power attenuation threshold in the reverse link. In practice, if there is less power attenuation, indicative of a terminal close to a base station or high power levels, than an OFDM mode will be chosen over an S-OFDM mode since it has higher capacity. However, if there is more power attenuation, indicative of a terminal far from a base station or low power levels, than an S-OFDM system will be chosen over an OFDM system since it benefits from a low PAR.

In another embodiment, the performance factors are a number of pilot tones used for reverse link transmission, and the selection criterion is a threshold number of tones. In practice, more tones produce a higher PAR for both S-OFDMA and OFDMA. Yet the PAPR for S-OFDMA increases more slowly with the number of tones than OFDMA. Normally the more the tones are, the larger the PAPR difference is between OFDMA and DFT S-OFDMA. Therefore, if there are more tones, indicating a high PAPR for OFDMA, then S-OFDM system will be chosen over an OFDM system.

In another embodiment, the performance factors are a number of data tones used for reverse link transmission along with the time duration of the transmission, and the selection criterion is the power consumption of that transmission. The number of tones used for reverse link transmission determines the PAPR of the transform, and the time duration determines the time when the power amplifier, baseband circuitry, modulator and frequency synthesizer and so on has to be functioning. Also when a simple receiver is used at the base station side such as MMSE frequency domain equalizer for DFT S-OFDMA, there is a performance difference between OFDMA and DFT S-OFDMA. More specifically, when HARQ is used, DFT S-OFDMA may need more retransmissions on average than OFDMA if all the DFT S-OFDMA and OFDMA transmissions are required to operate at the same output power. Consequently, the expectation of the power consumption can be calculated for DFT S-OFDMA and OFDMA, and the retransmission scheme leading to less power consumption is chosen.

In another embodiment, the estimating step includes a power de-rating estimate as performance factors for both modes, and the selection criterion includes a threshold level. The calculation of power de-rating for each mode can be done according to the number of tones, the modulation schemes, and power amplifier dependent parameters. In another embodiment, the performance factor is a battery usage policy of a terminal, and the selection criterion includes whether the usage policy promotes high power use or low power use. If the policy of a terminal is to use maximum available power then an OFDM system will be chosen over an S-OFDM system. However, if the terminal is operating under “power-saver” mode, then an S-OFDM system will be chosen over an OFDM system since it benefits from a lower power use.

In another embodiment, the performance factor includes a remaining battery life of a terminal, and the selection criterion includes a time or power level threshold for battery life. If the battery life is not presently limited then an OFDM system will be chosen over an S-OFDM system. However, if the terminal has limited battery life, then an S-OFDM system will be chosen over an OFDM system since it benefits from a lower power use.

In another embodiment, the performance factor is a power class of a terminal, and the selection criterion includes whether the power class promotes high power use or low power use. If the terminal is a handheld mobile device it would typically be limited to battery power, whereas if the terminal is a fixed terminal it would typically have mains power. Therefore, low power class terminals can use an S-OFDM system while high power class terminals can use an OFDM system.

In another embodiment, the performance factor includes a power mode of a terminal, and the selection criterion includes a determination of whether a mobile station is operating on limited battery (DC) power or unlimited mains (AC) power. If using mains power then an OFDM system will be chosen over an S-OFDM system. However, if the terminal using battery power, then an S-OFDM system can be chosen over an OFDM system since it benefits from a lower power use.

In another embodiment, the performance factor includes operational factors in a PAPR reduction zone, and the selection criterion includes whether or not the terminal operates in the PAPR reduction zone. If the terminal is operating with a PAPR reduction zone then operation in an OFDM system is preferred. The selection criterion can also include the number of tones used, where fewer tones can also select an OFDM system.

In another embodiment, the performance factor includes spurious frequency generation, and the selection criterion includes a spectral mask requirement. If there is a spurious frequency problem or there is a spectral mask requirement, then S-OFDM will be chosen over an OFDM system, since S-OFDM performs better in a spurious frequency environment.

In another embodiment, the determining step includes determining a base station receiver capability associated with the modulation scheme and communication mode, and wherein the estimating and selecting steps are performed in response to the base station receiver capability. If a base station has a receiver with high processing capability, this can be used to better advantage in an S-OFDM system. In practice, a look-up table listing the PAR for various modulation schemes in particular communication mode, and including the base station receiver capability can be used to select the best OFDM system.

In another embodiment, the selection criterion includes the use of a turbo equalizer, wherein if a turbo equalizer is being used in the base station receiver, this is indicative of a receiver with high processing power, wherein the selecting step selects the S-OFDM communication mode.

In another embodiment, the selection criteria includes an error rate and whether a frequency domain equalizer is being used in the base station receiver, wherein the selecting step selects the first communication mode if the modulation scheme is a Quadrature Amplitude Modulation (QAM) scheme of order sixteen (QAM16) or higher and the error rate is above a predetermined threshold, such as a Block error rate-to-packet error rate (BLER/PER) ratio threshold of 0.01, for example.

It should be understood that the performance factors can be obtained through calculation, pre-stored table lookup, measurement circuitry on the terminal such as peak detector.

In summary, one possible advantage of OFDMA over S-OFDMA is that it needs a lower SNR to achieve a certain PER when the SNR is high and a simple estimation method is used at the base station side. DFT S-OFDMA needs a similar SNR or even a lower SNR than OFDMA to achieve the same PER. Consequently, the merit of DFT S-OFDMA and OFDMA depends on many factors. As a result, a hybrid system that selects the communication mode based upon performance factors and selection criterion provides an advantage over the prior art.

### Simulation Results

In the following, OFDM system comparisons are made based on SNR requirement, coded modulation scheme and the base station receiver capability to illustrate the transmission means selection.

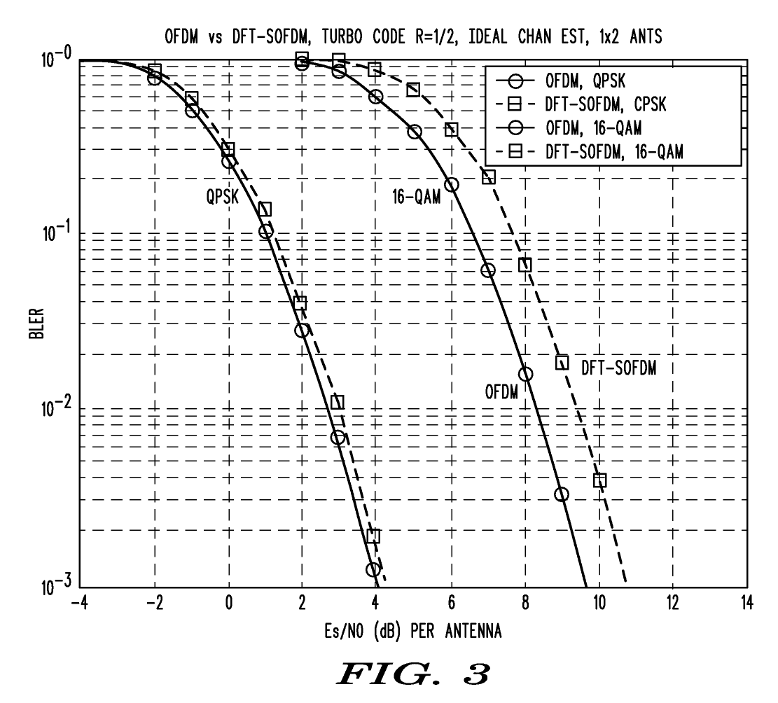

FIG. 3 shows a system where a base station receiver uses frequency domain equalization and the coding rate is ½ (turbo coding). The graph shows that the performance of DFT-OFDMA is close to that of OFDMA when QPSK is used. And OFDMA enjoys more than 1 dB advantage over DFT S-OFDMA when QAM16 is used.

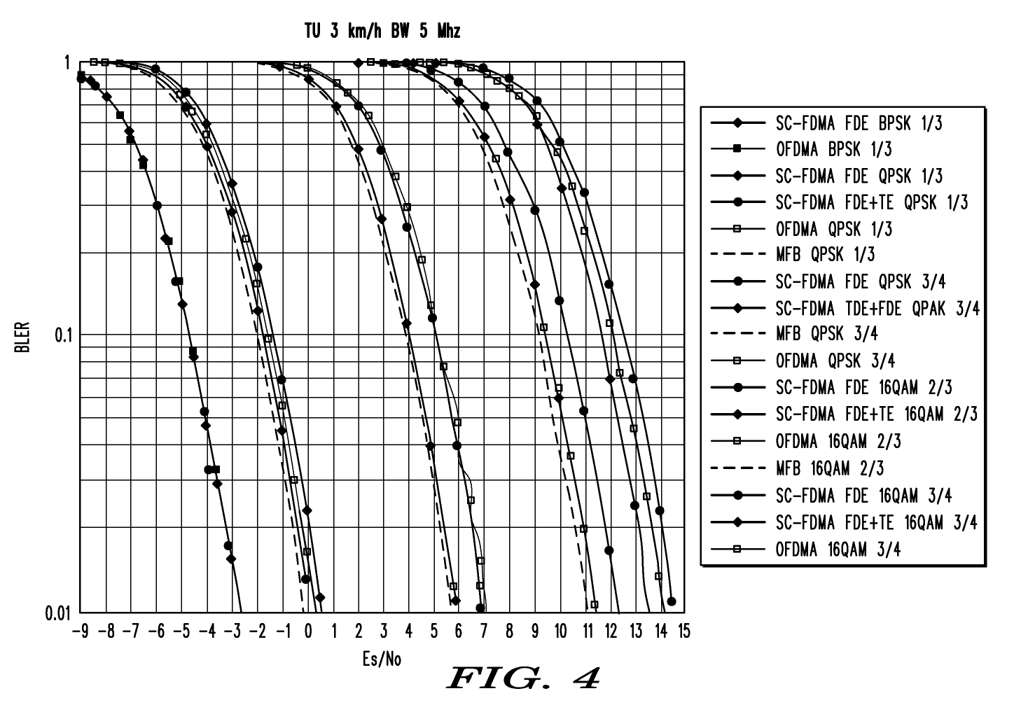

FIG. 4 shows a system where a base station receiver uses a turbo equalizer instead of frequency domain equalizer, using various modulation schemes and coding rates. As can be seen, the performance gap is closed and is even reversed at times: i.e. DFT S-OFDMA needs a lower SNR to achieve the same PER than OFDMA.

From these graphs, the following conclusions can be made:

a) When a frequency domain equalizer is used and the required SNR to achieve a BLER/PER at 0.01 is used as the selection criterion, OFDMA should be the preferred transmission means for QAM16 and higher coding rates;

b) S-OFDMA and OFDMA require similar SNR for QPSK and lower coding rates;

c) When turbo equalizer is used, DFT S-OFDMA should always be the preferred transmission means; and

d) In a hybrid system, the base station or terminal can make the transmission means selection according to the coded modulation schemes and base station receiver capability.

It can be imagined that the terminal can feed back all the needed operational parameters information to the base station, so any selection on the transmission scheme (i.e. OFDMA or S-OFDMA) can be made by the base station. Yet it is more plausible that there will be so many types of access terminals with different usage requirements (high throughput, long battery life, mobile/portable/fixed, etc), it can be quite difficult to build a good transmission means selector on the base station side. Also new types of access terminals can be designed and deployed faster than base station software releases, which makes it difficult for the base station transmission selector up-to-date with the emerge of new types of access terminals. Hence it is preferred that the decision maker (or at least recommender) resides on the terminal side.

The terminal can either send the recommended transmission means to the base station (in this case the terminal needs to know the planned reverse resource allocation (number of tones, modulation, time duration, etc.) before sending the recommendation, which is difficult, or use the selected transmission means directly when allowed by a base station. In the later case, the terminal needs to indicate to the base station the transmission means (OFDMA or DFT S-OFDMA). The indication can signaled to the base station along with reverse link transmission format or signaled separately.

The invention can be implemented in any suitable form including hardware, software, firmware or any combination of these. The invention may optionally be implemented partly as computer software running on one or more data processors and/or digital signal processors. The elements and components of an embodiment of the invention may be physically, functionally and logically implemented in any suitable way. Indeed the functionality may be implemented in a single unit, in a plurality of units or as part of other functional units. As such, the invention may be implemented in a single unit or may be physically and functionally distributed between different units and processors.

Although the present invention has been described in connection with some embodiments, it is not intended to be limited to the specific form set forth herein. Rather, the scope of the present invention is limited only by the accompanying claims. Additionally, although a feature may appear to be described in connection with particular embodiments, one skilled in the art would recognize that various features of the described embodiments may be combined in accordance with the invention. In the claims, the term comprising does not exclude the presence of other elements or steps.

While the invention has been particularly shown and described with reference to a particular embodiment, it will be understood by those skilled in the art that various changes in form and details may be made therein without departing from the spirit and scope of the invention. For example, although the above description was given primarily involving OFDM modulation, one of ordinary skill in the art will recognize that other multi-carrier and spread modulation techniques may be utilized as well. Additionally, although the embodiments described above deal with time and frequency spreading separately, one of ordinary skill in the art will recognize that a combination of both simultaneous time and frequency spreading as described above may be utilized as well. It is intended that such changes come within the scope of the following claims.

Furthermore, the order of features in the claims do not imply any specific order in which the features must be worked and in particular the order of individual steps in a method claim does not imply that the steps must be performed in this order. Rather, the steps may be performed in any suitable order. In addition, singular references do not exclude a plurality. Thus references to “a”, “an”, “first”, “second” etc do not preclude a plurality.

What is claimed is:

1. A method for switching between a first and a second Orthogonal Frequency Division Multiplexing (OFDM) communication mode, the method comprising the steps of:
establishing an operational modulation scheme;
estimating a first performance factor for the modulation scheme in the first communication mode and a second performance factor for the modulation scheme in the second communication mode;
comparing the first and second performance factors against at least one selection criterion;
selecting the communication mode in response to the selection criterion and the modulation scheme; and
transmitting on the selected communication mode using the modulation scheme.

2. The method of claim 1, wherein the method is operable on a reverse link.

3. The method of claim 1, wherein the establishing, estimating, comparing, and selecting steps are performed in a base station.

4. The method of claim 1, wherein the steps are performed in a terminal.

5. The method of claim 1, wherein the first communication mode is an OFDM communication mode and the second communication mode is an S-OFDM communication mode

6. The method of claim 5, wherein the determining step includes determining a base station receiver capability associated with the modulation scheme and communication mode, and wherein the estimating and selecting steps are performed in response to the base station receiver capability.

7. The method of claim 6, wherein the selection criterion is whether a turbo equalizer is being used in the base station receiver, wherein the selecting step selects the second communication mode.

8. The method of claim 6, wherein the selection criterion includes an error rate and whether a frequency domain equalizer is being used in the base station receiver, wherein the selecting step selects the first communication mode if the modulation scheme is a Quadrature Amplitude Modulation (QAM) scheme of order sixteen (QAM16) or higher.

9. The method of claim 1, wherein the performance factors are a power attenuation in the reverse link, and the selection criterion includes a power attenuation threshold in the reverse link.

10. The method of claim 1, wherein performance factors are a number of pilot tones used for reverse link transmission, and the selection criterion is a threshold number of tones.

11. The method of claim 1, wherein the estimating step includes a power de-rating estimate as performance factors for both modulation schemes, and wherein the selection criterion includes a threshold level.

12. The method of claim 1, wherein the performance factor is a battery usage policy of a terminal, and the selection criterion includes whether the usage policy promotes high power use or low power use.

13. The method of claim 1, wherein the performance factor includes a remaining battery life of a terminal, and the selection criterion includes a threshold for battery life.

14. The method of claim 1, wherein the performance factor includes a power mode of a terminal, and the selection criterion includes a determination of whether a mobile station is operating on battery power or AC (alternate current) power.

15. The method of claim 1, wherein the selection criteria includes a power consumption of the transmission, a number of tones used for transmission, and a duration of the transmission.

16. The method of claim 1, wherein the performance factor includes an indication of a PAPR reduction zone, and the selection criterion includes whether or not the terminal operates with the PAPR reduction zone.

17. The method of claim 1, wherein the performance factor includes spurious frequency generation, and the selection criterion includes a spectral mask requirement.

18. The method of claim 1, wherein the performance factor is a power class of a terminal, and the selection criterion includes whether the power class promotes high power use or low power use.

19. A terminal operable to switch between a first and a second Orthogonal Frequency Division Multiplexing (OFDM) communication mode, the terminal comprising:
a transceiver operable to use a modulation scheme; and
a processor, the processor operable to; estimate a first performance factor for the modulation scheme in the first communication mode and a second performance factor for the modulation scheme in the second communication mode, comparing the first and second performance factors against at least one selection criterion; and select the communication mode in response to the selection criterion and the modulation scheme, wherein the transceiver communicates with a base station to switch to the selected communication mode and transmits on a reverse link of the selected communication mode using the modulation scheme.

20. A base station operable to switch between a first and a second Orthogonal Frequency Division Multiplexing (OFDM) communication mode the base station comprising:
a transceiver operable to use a modulation scheme; and
a processor, the processor operable to; estimate a first performance factor for the modulation scheme in the first communication mode and a second performance factor for the modulation scheme in the second communication mode, comparing the first and second performance factors against at least one selection criterion; and select the communication mode in response to the selection criterion and the modulation scheme, wherein the transceiver communicates with a terminal to switch to the selected communication mode and transmit on a reverse link of the selected communication mode using the modulation scheme.
